(19) United States
(12) Patent Application Publication
(10) Pub. No.: US 2005/0123811 A1
(43) Pub. Date: Jun. 9, 2005

(54) Fuel cell device, and method of operating the fuel cell device

(76) Inventor: Ulrich Gottwick, Stuttgart (DE)

Correspondence Address: STRIKER, STRIKER & STENBY, 103 EAST NECK ROAD, HUNTINGTON, NY, 11743, US

(21) Appl. No.: 10/964,514

(22) Filed: Oct. 13, 2004

(30) Foreign Application Priority Data
Oct. 14, 2003 (DE) 103 47 793.4

(51) Int. Cl. H01M 8/04; H01M 8/10

(52) U.S. Cl. 429/22; 429/25; 429/30; 429/23; 429/13

(57) ABSTRACT

A fuel cell device has a fuel cell unit, at least one adjusting element for influencing at least one fuel stream of the fuel cell unit, a control unit for controlling and/regulating of at least one adjusting element, the control unit being formed so that at least in one operational mode it provides a periodic filling and emptying of the fuel cell unit.

### BACKGROUND OF THE INVENTION

The present invention relates to a fuel cell device, and also to a method of operating the fuel cell device.

Modern fuel cell systems both for stationary and for mobile applications are generally operated so that the anode side is supplied with fuel, in particular hydrogen, and the cathode side is supplied with oxygen, in particular air. The supplied and the withdrawn gas streams are pumped or blown in and out of the fuel cell stack. This means that the current fuel cell stacks operate in a through flow or the operating material streams flow through them.

Partially, on the anode side of the stack a relatively high quantity of not converted hydrogen is blown off. Partially, the hydrogen containing anode waste gas is pumped or recycled in a circle, to improve the total efficiency of the system.

Furthermore, conventionally at least the cathode gas is moisturized before the entry in the fuel cell stack, in order not to dry the protons-guiding membrane of the stack. Corresponding membranes or MEAs (Membrane Electrode Assembly) must have a certain average moisture, to conduct the protons. Along the flow path of the cathode gas, water is produced which is partially taken by the cathode gas. Partially, so much water can be produced on the membrane, that water stays on the membrane and thereby the contact of the hydrogen protons passing through the membrane with the oxygen molecules of the cathode gas no longer can be completely guaranteed.

The above described as well as other effects lead for example to local drying and wetting of the membrane, depletion of the operation gas, temperature changes, wherein also temperature influences act on conductivity of the membrane, so that during the through flow of the stack high inhomogenuities occur with respect to the gas composition, stack and gas temperature, membrane and gas moisture, as well as the pressure. This inhomogenuities reduce the efficiency of the fuel cell system.

### SUMMARY OF THE INVENTION

Accordingly, it is an object of the present invention to provide a fuel cell device, which avoids the disadvantages of the prior art.

More particularly, it is an object of the present invention to provide a fuel cell device with a fuel cell unit and a control unit for controlling and/or regulation of at least one adjusting element, wherein the adjusting element is formed for influencing at least one operational substance (fuel) stream of the fuel cell unit, and also to provide a method of operating a fuel cell device, wherein inhomogenuities of the fuel cell unit or the membrane are significantly reduced.

In keeping with these objects and with others which will become apparent hereinafter, one feature of the present invention resides, briefly stated, in a fuel cell device, comprising a fuel cell unit; at least one adjusting element for influencing at least one fuel stream of said fuel cell unit; a control unit for controlling and/regulating of at least one adjusting element, said control unit being formed so that at least in one operational mode it provides a periodic filling and emptying of said fuel cell unit.

Another feature of the present invention resides, briefly stated, in a method of operating a fuel cell device, comprising the steps of flowing a fuel stream into a fuel cell unit; flowing at least partially converted fuel stream out of the fuel cell unit; and providing at least one filling phase for filling the fuel stream and emptying phase, which substantially follows in time, for emptying at least partially converted fuel stream.

The fuel cell device in accordance with the present invention, in addition to other structural elements, is formed so that at least in one operating mode the control unit is formed for periodic filling and emptying of the fuel cell unit.

The method in accordance with the present invention, in addition to other method features, is performed so that at least one filling phase for filling the fuel stream and one substantially subsequent emptying phase for emptying the at least partially converted fuel stream are provided.

With the present invention, in particular the operation of the fuel cell device is realized in a cycled fashion or in a charge fashion. In contrast to the prior art, in which due to the throughflow operation almost always local inhomogenuities are produced or reinforced, the corresponding inhomogenuities in the present invention, due to filling and the emptying of the fuel cell element or due to the filling phase and the emptying phase, are destroyed or can not develop to a degree as in the prior art. Thereby, the membrane can be relatively uniformly moisturized and tampered.

Moreover, a depletion of the relevant gas components, in particular of hydrogen and oxygen, in the fuel cell is substantially prevented. Correspondingly, the efficiency of the fuel cell system when compared with the prior art is significantly increased and the loading of the fuel cell stack or the membrane is significantly reduced, which is exhibited in a higher service life of the stack.

The periodic filling or emptying of the fuel cell unit or the fuel cell stack can be realized by a change of the cathode and/or anode volume. For example it is recommended that the fuel cell stack can be formed in the form of a bellows or the same, wherein periodic filling or emptying is realized by corresponding volume changes.

Preferably, the control unit is formed for changing a pressure of the fuel stream. By means of a correspondingly formed control unit, the filling or emptying is realized by a pressure increase or a pressure reduction. Correspondingly, expensive constructions for changing the volume of the corresponding fuel cell units are dispensed with and/or commercially available components can be used with small structural changes, which ensures an especially efficient realization of the invention.

A pressure-loaded storage can be provided in accordance with the present invention for storing the fuel stream. By means of an adjusting element, such as for example a regulating valve or the like, the pressure change of the fuel stream can be converted for the periodic filling or emptying of the fuel cell unit.

Alternatively, or in combination with it, at least one pressure generating unit can be provided for generation of the pressure change of the fuel stream. The pressure generating unit can be formed for example as a blower, fan and/or condensor so that by controlling or regulating the pressure generating unit by means of the control unit, an advantageous adaptation of the fuel pressure can be provided.

In accordance with a special further embodiment of the present invention, in the region of the proton conducting membrane of the fuel cell unit, at least one direction change is provided between a filling direction of the fuel stream and an emptying direction of the at least partially converted fuel stream. It is possible that the filling direction is substantially opposite to the emptying direction. With this feature it is guaranteed that at least a partial region of the fuel stream flows preferably twice or many times over. Thereby in advantageous manner, inhomogenuities with respect to the gas composition, stack and gas temperature, membrane and gas moisture as well as the pressure are substantially compensated. Therefore, an especially efficient reduction of the inhomogenuities and an especially advantageous increase of the efficiency of the fuel cell system are provided.

In some cases, for example depending on the fuel stream, a filling and a separate emptying opening of the fuel cell unit are provided. It is possible that the filling openings and the emptying openings are arranged in the same side of the fuel cell unit or the fuel cell stack. It is recommended to provide several filling openings and/or several emptying openings depending on the fuel stream.

In a preferable embodiment of the invention, a filling opening of the fuel cell unit corresponds to an emptying opening of the fuel cell unit. Thereby an especially simple, efficient favorable embodiment of the invention can be realized. For example, a closing or an opening element for opening or closing of the corresponding opening is provided. Correspondingly the structural expenses are reduced.

Advantageously, the fuel stream is formed as an oxidation medium stream, in particular as air stream of a cathode of the fuel cell unit. Frequently, alternatively or in combination with it, the reduction medium stream or hydrogen stream is formed on the anode of the fuel cell unit as a fuel stream in accordance with the invention. Preferably, a filling phase and an emptying phase of the oxidation medium stream, as well the reduction medium stream are substantially realized in the same time or in the same phase. Thereby the substantially pressure-sensitive membrane of the fuel cell unit is loaded substantially uniformly with pressure from both sides, so that a negative effect on the membrane is efficiently prevented.

In a preferable variant of the invention, the control unit is formed for adaptation of the pressure changes of the fuel stream depending on the power output of the fuel cell unit. With this feature, the fuel cell unit can be advantageously adapted to dynamic load requirements, in particular in mobile or vehicle applications in advantageous manner.

Preferably, for example an amplitude, a frequency and/or an average value of the amplitude or the pressure changes of the fuel stream, are substantially proportional to the power output of the fuel cell unit. For example a spreading of the amplitude and/or an increase of the average value of the amplitude is provided with an increase of the power output. It is possible that the frequency of the periodic pressure change or the filling and/or emptying phase is adapted proportionally to the power output, wherein an increase of frequency is provided with an increase of the stack output power.

Preferably, a volume of the cathode of the fuel cell unit is substantially greater than a volume of the anode of the fuel cell unit. For example, the cathode volume is many times or approximately 4 times greater than the anode volume of the fuel cell unit. Thereby in an advantageous manner an air gulping at the cathode side by consumed oxygen is correspondingly weakened or completely prevented. It is possible to provide a post-regulation of the oxygen concentration of the cathode side. Alternatively, or in combination with it, in the anode side, the pressure buildup can take place by hydrogen consumption because of the fuel cell action, which by means of the control unit or at least one pressure buildup regulator can be continuously regulated or post-controlled. Thereby a substantially constant average hydrogen concentration at the anode side is available.

In general, with the pressure fluctuation of the fuel stream, in particular by partial pressure fluctuation, in the fuel cell unit a change or fluctuation of the stack voltage occurs. This can be taken care of or compensated in an advantageous manner substantially by a corresponding power electronics, in particular by means of a DC/DC convertor.

Generally, the gasses which flow into the fuel cell can be heated or tampered by one or several heat exchangers in advantageous manner by the outflowing gas or another heating fluid.

In an advantageous embodiment of the invention, at least one sensor is provided for detecting a partial pressure, in particular of the oxygen and/or the hydrogen. Alternatively, or in combination with it, also the moisture content of an at least one fuel stream can be detected or sensed by means of an advantageous sensor. The control unit in accordance with the present invention controls or regulates corresponding adjusting members such as valves, pressure generating units, fuel storage, etc.

Basically, corresponding fuel cell devices can be used in so-called APU applications and/or in travel drive systems or in stationary applications.

Summarizing the above, it should be emphasized that the core of the invention is a filling and emptying of the fuel cell unit, which is substantially similar to breathing of living beings. This leads to the situation, that first of all, by inflow of the cathode gas or outflow of the cathode gas in an opposite direction, contrary to the prior art, it flows many times at least through a partial region of the membrane and thereby takes water formed on the membrane during the filling in, and gives out water from the membrane during emptying, so that both the formation of differently moisturized membrane regions and thereby directly interacting, different temperature distributions of the membrane are efficiently eliminated or reduced. Correspondingly, the efficiency of the fuel cell system is increased.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing a block diagram of an inventive fuel cell device; and

FIG. 2 is a view schematically showing a course of pressure changes in the inventive fuel cell device.

### DESCRIPTION OF THE PREFERRED EMBODIMENTS

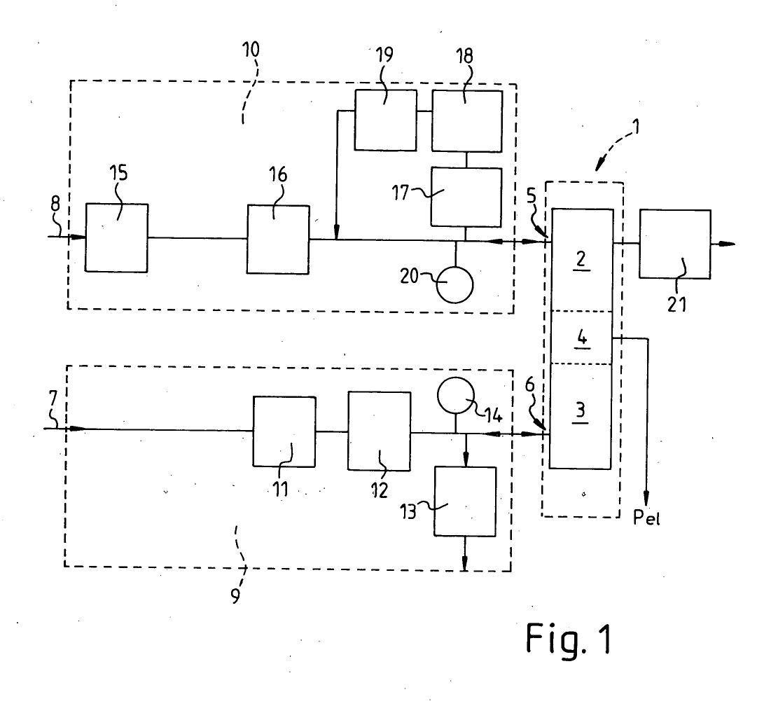

FIG. 1 schematically shows the construction of a fuel cell device in accordance with the present invention. The fuel cell device has a fuel cell 1 with an anode 2, a cathode 3 and a membrane 4. An electric power Pₑᵢ is available on the membrane 4.

The fuel cell 1 in the shown embodiment has an opening 5 of the anode 2 and an opening 6 of the cathode 3, through which air 7 or a hydrogen-containing gas 8 can flow in and flow out. Thereby the fuel cell 1 in accordance with the present invention is periodically filled and emptied.

For periodically filling and emptying, an oxygen supply 9 and a hydrogen supply 10 have several, in particular controllable or regulatable components.

For example, the fuel supply 9 of the fuel cell 1 includes a compressor 1, which for example aspirates atmospheric air from the environment and compresses it to the required operational pressure. For fine adjustment of the oxygen or air pressure of the oxygen supply 9, a pressure regulating valve 12 can be provided. Furthermore, the oxygen supply 9 includes a pressure drain valve 13 and a pressure measuring element 14.

A not shown control unit for control or regulation of the valves 12, 13 as well as of the compressor 11 opens for example the valve 12 in the filling phase, whereas the pressure drain valve 13 is closed, so that pressure loaded oxygen flows into the cathode 3. In the emptying phase the pressure regulating valve 12 is partially or completely closed and the pressure drain valve 13 is open, so that the pressure in the cathode 3 is reduced approximately to environment pressure, wherein at least partially converted air flows out of the system.

Correspondingly, the cathode 3 is filled or emptied, generally in the same phase as the anode 2 with pressure loaded hydrogen 8. For this purpose the fuel supply 10 has for example a storage 5, which intermediately stores the hydrogen 8 or hydrogen-containing gas. In some cases the hydrogen is produced on-board in a vehicle by means of a reformer or the like from hydrocarbons, such as gasoline or diesel, etc. In some cases the hydrogen 8 can be stored in a tank directly in liquid or gaseous form.

The tank 15 filled with the pressure-loaded hydrogen 8 is arranged in a flow direction before the pressure regulating valve 16. Therefore an advantageous fine regulation of the hydrogen 8 which acts with pressure on the anode 2 can be realized. Correspondingly at the cathode side the filling phase is realized so that the pressure regulating valve 6 and the purge valve 17 is closed. The emptying phase of the anode 2 is thereby converted, so that the valve 16 is closed and the valve 17 is open, and therefore at least partially converted hydrogen 8 can be available for recycling or repeated use via a container 18 and a compressor 19 of the anode in the filling phase. Due to the circulation guidance of the partially converted hydrogen 8 the total efficiency of the system is advantageously increased.

A pressure measuring element 20 and 14 is connected with the advantageous control unit, not shown in the drawings. It senses the pressure produced on the cathode 3 or on the anode 2 and advantageously controls or regulates the corresponding components of the system. An optionally provided spraying valve 21 is arranged in advantageous manner on the cathode 9, so that in some cases in a spraying phase the anode 2 is can be sprayed in a through flow. For this purpose some accumulated residual gas or the like is removed without great expenses from the anode 2. The spraying valve 21 can be connected to the input 5, so that instead of the through flow a return flow is generated. Thereby the stack structure is generally somewhat simplified. It is possible that the cathode 3 includes a corresponding spraying unit, not shown in the drawings.

The fuel cell 1 in accordance with the present invention, in contrast to the prior art, is operated most of the time not in a through flow operation, but instead in a periodic filling and emptying operation. For this purpose the outputs available in the prior art in conventional fuel cell units 1 are closed, so that the filling and the emptying can be performed in some cases by means of the same opening 5 or 6.

Advantageously, at the anode and the cathode side the pressure is substantially increased in the same phase, which prevents a destruction of the membrane 4 by damaging pressure differences in an efficient way. Subsequently, the pressure buildup ends and in some cases the gasses 7, 8 are locked in the fuel cell unit 1 during a predetermined time. With the purge valve 17, the pressure at the anode side is lowered in the hydrogen container 18, and at the cathode side 3 via an outlet valve 13 the pressure also is lowered, however outwardly into the environment. Subsequently the hydrogen gas 8 is pumped from the container 18 by a compressor or condensor 19 into the stack 1 or into the anode 3. At the cathode side 3, the pressure is correspondingly increased by the pressure regulating valve 12.

The anode side pressure reduction, due to hydrogen consumption because of the fuel cell operation, is continuously regulated by means of the pressure regulating element 20 and a fuel unit. In some cases with high stack output power, for example the frequency of the periodic modulation or the filling and emptying of the fuel cell unit 1 is increased, and with low stack powers is correspondingly reduced. In some cases alternatively the operation can be performed with particularly slow, variable operational pressure and in some cases with superimposed pressure modulation. The modulation value can be adjusted in some cases to the power output of the stack 1.

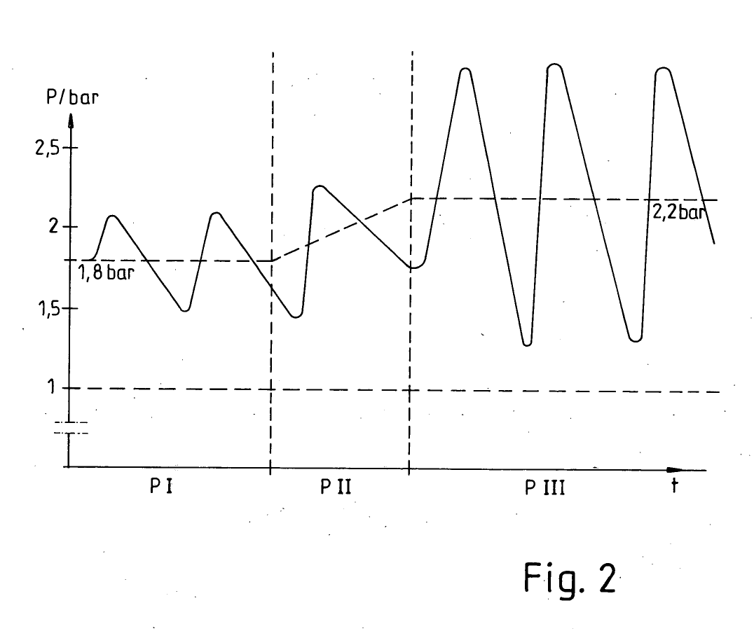

A corresponding change of the pressure modulation is schematically shown in FIG. 2. For example in a phase PI the air 7 or the hydrogen 8 fills the fuel cell 1 or is emptied from it with an average pressure of approximately 1.8 bar and an amplitude of approximately 0.6 bar. With a load change from the phase PI to a phase PIII, an intermediate phase PII is provided, so that in the phase PIII for example the average pressure of the modulation is increased to approximately 2.2 bar and an amplitude is available at approximately 1.6 bar. In phase PI the stack 1 provides a lower power to a corresponding consumer that in the phase PII. Correspondingly, the pressure in the phase PI changes modulated as in phase PIII and, as described above, the average pressure level correspondingly changes. Low pressure differences between the anode and the cathode side are tolerable within a certain range provided by the stack construction.

The pressure course basically can be approximately sine-shaped, as shown for example in FIG. 2. Alternatively, the pressure course can run however substantially rectangularly or substantially rounded or in another fashion. Generally, the pressure course is provided by the properties or dynamics of the pressure generator and/or the available fuel cell components, which act for example in a corresponding damping of the pressure course.

It will be understood that each of the elements described above, or two or more together, may also find a useful application in other types of constructions differing from the types described above.

While the invention has been illustrated and described as embodied in fuel cell device, and method of operating the fuel cell device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A fuel cell device, comprising a fuel cell unit; at least one adjusting element for influencing at least one fuel stream of said fuel cell unit; a control unit for controlling and/regulating of at least one adjusting element, said control unit being formed so that at least in one operational mode it provides a periodic filling and emptying of said fuel cell unit.

2. A fuel cell device as defined in claim 1, wherein said fuel cell unit is formed so that it changes a pressure of said fuel stream.

3. A fuel cell device as defined in claim 1; and further comprising at least one pressure generating unit for generating a pressure change of said fuel stream.

4. A fuel cell device as defined in claim 1; and further comprising a proton conducting membrane; and mean for providing at least one direction change between a filling direction of said fuel stream and an emptying direction of at least partially converted fuel stream, and located in a region of said proton conducting membrane.

5. A fuel cell device as defined in claim 1, wherein said control unit is formed so that a filling direction is substantially opposite to an emptying direction.

6. A fuel cell device as defined in claim 1, wherein said fuel cell unit has a filling opening and an emptying opening which correspond to one another.

7. A fuel cell device as defined in claim 1, wherein said fuel cell unit has a cathode, wherein the fuel stream is formed as an oxidation medium stream of said cathode of said fuel cell unit.

8. A fuel cell device as defined in claim 1, wherein said control unit is formed for adapting pressure changes of the fuel stream depending on a power output of said fuel cell unit.

9. A fuel cell device as defined in claim 1; and further comprising means for providing an amplitude of the pressure changes of the fuel stream to be substantially proportional to a power output of said fuel cell unit.

10. A method of operating a fuel cell device, comprising the steps of flowing a fuel stream into a fuel cell unit; flowing at least partially converted fuel stream out of the fuel cell unit; and providing at least one filling phase for filling the fuel stream and emptying phase, which substantially follows in time, for emptying at least partially converted fuel stream.

11. A method of operating a fuel cell device as defined in claim 10; and further comprising performing the filling phase and the emptying phase alternatingly with one another.

12. A method of operating a fuel cell device as defined in claim 10; and further comprising executing the filling phase and the emptying phase with an oxidation medium stream and a reduction medium stream which flow substantially at the same time.

13. A method of operating a fuel cell device, comprising the steps of using a fuel cell device which has a fuel cell unit, at least one adjusting element for influencing at least one fuel stream of said fuel cell unit; a control unit for controlling and/regulating of at least one adjusting element, and performing by said control unit, at least in one operational mode, a periodic filling and emptying of said fuel cell unit.
